(19) United States
(12) Patent Application Publication
(10) Pub. No.: US 2019/0197892 A1
(43) Pub. Date: Jun. 27, 2019

(54) FLOOD WARNING SYSTEM AND PROCESS FOR DETECTING A LEVEL OF WATER IN A WATERWAY

(71) Applicant: Kyle Lynn WATSON, Pinehurst, TX (US)

(72) Inventor: Kyle Lynn WATSON, Pinehurst, TX (US)

(21) Appl. No.: 16/293,862

(22) Filed: Mar. 6, 2019

Related U.S. Application Data
(63) Continuation of application No. 15/937,996, filed on Mar. 28, 2018.
Application No. 15/937,996 is a continuation-in-part of application No. 15/474,873, filed on Mar. 30, 2017, now abandoned.
(60) Provisional application No. 62/344,823, filed on Jun. 2, 2016.

(51) Int. Cl. G08G 1/095; G01F 23/00; G01F 23/30

(52) U.S. Cl. CPC G08G 1/095; G01F 23/36; G01F 23/30; G01F 23/00

(57) ABSTRACT

A flood warning system has a gauge unit adapted to be positioned adjacent to a waterway and a display adapted to be positioned away from the waterway and adjacent to a roadway. The gauge unit has a plurality of sensors arranged in vertically-spaced relation within a housing of the gauge unit. The housing has a fluid inlet adapted to allow water to enter the housing when a level of water in the waterway raises above a low position. The plurality of sensors are adapted to detect a level of water within the housing of the gauge unit. The display has a warning indicator thereon. The display is cooperative with the gauge unit such that the warning indicator is actuated when the level of water in the housing of the gauge unit is above one of the plurality of sensors.

### CROSS-REFERENCE TO RELATED APPLICATIONS

The present application is a continuation-in-part of U.S. patent application Ser. No. 15/937,996, filed Mar. 28, 2018, presently pending. U.S. patent application Ser. No. 15/937,996 is a continuation-in-part of U.S. patent application Ser. No. 15/474,873, filed Mar. 30, 2017, now abandoned. U.S. patent application Ser. No. 15/474,873 claims priority from Provisional Patent Application Ser. No. 62/344,823, filed on Jun. 2, 2016.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

The present invention relates to flood warning systems for processes for detecting a level of water in a waterway. More particularly, the present invention relates to flood warning systems that can transmit a warning system to a location a significant distance away from a flooded waterway.

### 2. Description of Related Art Including Information Disclosed Under 37 CFR 1.97 and 37 CFR 1.98

Roadways are often flooded without warning. Motorists and pedestrians have no idea whether the current level of water of an area that is prone to flooding is dangerous until they attempt to cross the roadway. Often, a motorist will try to visually gauge the water depth as they cross the road. This often result in a flooded vehicle when the level of water is too deep.

Currently, flood warning systems use a static sign that includes a gradient to measure water depth. The sign must be read by physically approaching the body of water and manually reading the sign. This presents a danger to the person reading the sign since the area may already be too dangerous to enter when flood waters are present. It is common for a government employee to post a road closure only after someone has been caught in flooded waters. Once a motorist gets caught in a flooded area, they will have to be rescued by fast-running water rescue squads or by an air lift. Both of these approaches are expensive and hazardous. Even when the person is rescued, the automobile becomes overwhelmed with water. This can cause extensive damage to the vehicle and require expensive repairs and/or replacement.

It is object of the present invention to provide a flood warning system that alerts persons on the roadway of the potential for or of current flooding of an area.

It is another object of the present invention to provide a flood warning system that does not require a person to manually evaluate flood conditions.

It is another object of the present invention to provide a flood warning system that does not require placement in the non-flooded waterway.

It is another object of the present invention to provide a flood warning system that minimizes the risk of damage to components when a flooding condition occurs.

It is another object of the present invention to provide a flood warning system that avoids the needs for extensive wiring.

It is still another object of the present invention to provide a flood warning system that can be easily installed.

It is still a further object of the present invention provide a flood warning system which does not require the motorist to have any training in order to ascertain the level of water.

These and other objects and advantages of the present invention will become apparent from a reading of the attached specification and appended claims.

### BRIEF SUMMARY OF THE INVENTION

The present invention the process a process for detecting a level of water in a waterway and or for providing a warning of the level of water in the waterway. As used herein, the term “waterway” includes rivers, streams, lakes, reservoirs, along with flood-prone roads and highway crossings. This process includes the steps of: (1) positioning a gauge unit in a location on a surface away from the waterway when the level of water in the waterway is at a low position; (2) sensing a level of water within the gauge unit when the level of water in the waterway raises above the low position; (3) positioning a display at a location remote from the waterway and adjacent to a roadway; (4) transmitting a signal from the gauge unit to the display relative to the level of water in the gauge unit; and (5) displaying an indicator on the display relative to the transmitted signal. The indicator provides information to a person on or at the roadway of the level of water in the waterway.

The process of the present invention further includes flowing the water from the waterway into a lower end of the gauge unit such that the water in the gauge unit raises or lowers relatives a level of water in the waterway. The step of sensing includes optically sensing the level of water. In particular, a plurality of optical sensors are arranged in vertically-spaced relation within the gauge unit. The plurality of optical sensors are directed toward the interior of the gauge unit.

The step of displaying an indicator includes forming an enclosure having a plurality of lights thereon. The plurality of lights are directed toward the roadway in a direction away from the waterway. The plurality of lights are of different colors. The step of transmitting the signal includes transmitting a signal to the plurality of lights so as to illuminate a first color of the lights when the water in the gauge unit has not reached a first level within the gauge unit. Another signal is transmitted to the plurality of lights so as to illuminate a second color when the water in the gauge unit has reached a second level in the gauge unit. The step of transmitting further includes transmitting a further signal to the plurality of lights so as to illuminate a third color of the lights when the water in the gauge unit has reached a third level within the gauge unit. The first signal is indicative of a safe condition. The second signal is indicative of a near-flooded or “caution” condition. The third signal is indicative of a flooded condition. The lights are green, yellow and red. The first color is illuminated when the water in the gauge unit is below a lowermost optical sensor of the plurality of optical sensors. An optical sensor is applied at a level within the gauge unit that is higher than the level of water in the waterway when the level of water in the waterway is at the low position. Another optical sensor is applied within the gauge unit at a level above the surface of the roadway adjacent to the waterway.

The present invention is also a flood warning system that comprises a gauge unit adapted to be positioned adjacent to a waterway and a display adapted be positioned away from the waterway and adjacent to a roadway. The gauge unit has a plurality of sensors arranged in vertically spaced relation within a housing of the gauge unit. The housing has a fluid inlet adapted to allow water to enter the housing when the level of water in the waterway raises above a low position. The plurality of sensors are adapted to detect the level of water within the housing of the gauge unit. The display has a warning indicator thereon. The display is cooperative with the gauge unit such that the warning indicator is actuated when the level of water in the housing of the gauge unit is above one of the plurality of sensors.

In the flood warning system of the present invention, the plurality of sensors are a plurality of optical sensors. A first sensor is positioned at a level higher than the low position of the level of water in the waterway. A second sensor is positioned at a level higher than a surface of the roadway adjacent to the waterway. The plurality of sensors are adjustably positioned within the housing.

The display has a housing with a plurality of lights positioned thereon. The plurality of lights are directed away from the waterway. The plurality of lights correspond to a level of water in the waterway. One of the plurality of lights is green. Another of the plurality of lights is red. The green is indicative of a non-flooded roadway. The red is indicative of a flooded roadway. A solar panel is affixed to the housing of the gauge unit. A battery is connected to the solar panel. The battery supplies power to the plurality of sensors in the gauge unit. The gauge unit is wirelessly connected to the display such that the plurality of sensors transmit signals wirelessly to the display.

This foregoing Section is intended to describe, with particularity, the preferred embodiments of the present invention. It is understood that modifications to these preferred embodiments can be made within the scope of the present claims. As such, this Section should not to be construed, in any way, as limiting of the broad scope of the present invention. The present invention should only be limited by the following claims and their legal equivalents.

### BRIEF DESCRIPTION OF THE SEVERAL VIEWS OF THE DRAWINGS

FIG. 1 is a side elevational view of the flood warning system of the present invention.

FIG. 2 is a front elevational view the gauge unit shown in the system of FIG. 1.

FIG. 3 is a cross-sectional view taken along line 2-2 of FIG. 2.

FIG. 4 is a side elevational view of a control unit in of the system of FIG. 1.

FIG. 5 is a front elevational view of the control unit of FIG. 2 is shown with the door open.

FIG. 6 is a front elevational view of the display unit in the system of FIG. 1.

FIG. 7 is a cross-sectional view taken along line 6-6 of FIG. 6.

FIG. 8 is an electronic schematic for the warning lights in the display of the present invention as related to the optical sensors of the gauge unit.

### DETAILED DESCRIPTION OF THE INVENTION

In general, the present invention provides an alert system that provides motorists an alert in advance of flooded areas or areas that are being flooded with rising water. As will be appreciated, aspects of the disclosed system provide real-time information on water levels adjacent or on top of the roadway. The present invention is intended to prevent loss of life and to avoid costly automotive repairs due to water damage. The present invention also serves to reduce or avoid expensive rescue efforts associated with motorists entering flooded waterways.

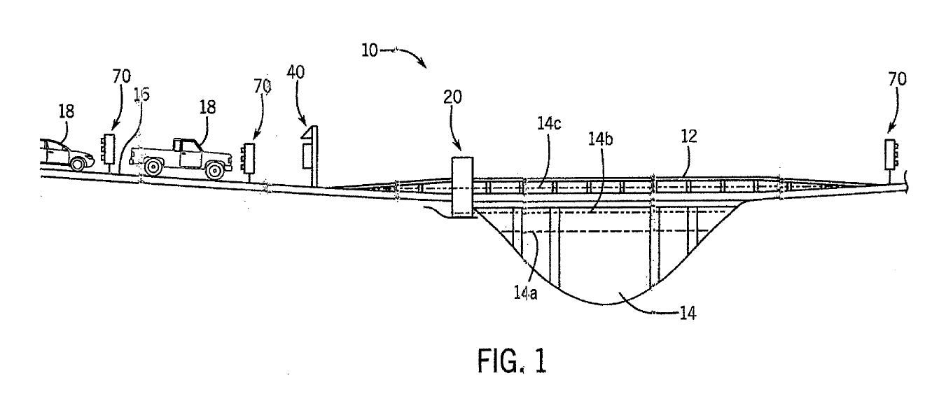

Referring to FIG. 1, the flood warning system 10 is shown in its preferred embodiment. The flood warning system 10 includes a remote gauge unit 20 in communication with the control unit 40 and one or more displays 70. Wiring can exist between the gauge unit 20, the control unit 40 and the warning light 70. However, in the preferred embodiment of the present invention, signals between the various units are transmitted wirelessly. The wireless transmission of information is intended to avoid the possible shorting effects caused by the flooded conditions and to avoid damage to wiring that can occur whenever areas are flooded. The use of wireless transmission also serves to reduce the costs associated with installation. The wireless transmission of signals between the gauge unit 20, the control unit 40 and the display 70 avoids improper operation under the circumstances where the wiring connection could be cut or damaged.

In operation, the flood warning system 10 is positioned adjacent to a waterway that is proximate to a roadway or a pedestrian path. The flood warning system 10 can also be positioned near roadways that are not necessarily next to a body of water that are subject to flash flooding when heavy rains come down. As used herein, the term “waterways” include river, streams, lakes, reservoirs, along with flood-prone road and highway crossings.

The gauge unit 20 is positioned proximate to the water in the waterway. The gauge unit 20 can be positioned near terrain that feeds flooding to the roadway. The gauge unit 20, shown in FIG. 1, is not positioned in the water but positioned to the side of the water or on a bank of the waterway when the water in the waterway is not in a flooding condition or is in a low-level/normal flow condition. The positioning of the water unit away from the water in the waterway (when the water is in a normally-flowing condition) enhances the ease and effectiveness of installation. Past efforts have positioned indicators within the actual waterway so that the level of water can be ascertained. The present invention is in contrast to markers or other indicator devices since it is not placed in the waterway but simply in an area that could be potentially flooded. As such, during installation, it is only necessary to take the gauge unit and to place the gauge unit on to a solid surface adjacent to those areas that can potentially become flooded. For example, as shown in FIG. 1, the gauge unit can be placed adjacent to a roadway or bridge that could be subject to flooding conditions. The gauge unit 20 can be positioned along the banks of the river 14 near a bridge 12 that includes a roadway 16 for vehicles. The display 70 can be positioned in advance of one or both ends of the bridge 12. The control unit 40 is positioned in proximity to the gauge unit 20 and the display 70. However, the control unit can be positioned distantly from the river 14 to avoid being overtaken by flood waters.

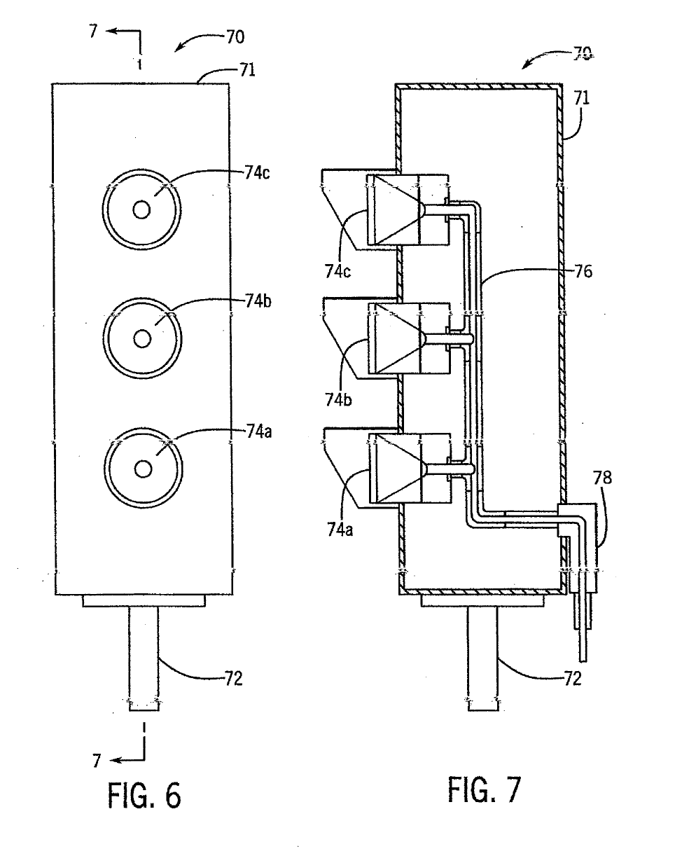

As the water level of the river 14 increases or decreases, the gauge unit 20 measures the level and sends a signal to the control unit 40 indicating the current water level. The control unit 40 responds to the signal by issuing a signal to the display 70 commanding the display 70 to illuminate a warning light dependent on current water levels. Details of the display 70 are described hereinbelow in FIGS. 6 and 7. In addition, the control unit 40 may issue commands to the other elements connected to the system 10, such as gates, drawbridges etc. to open or close depending on the water level.

In FIG. 1, the water level 14a represents a safe water level that is below the surface of the roadway 16. This would be considered the low position of the water level. Water level 14b represents an elevated water level as a result of increasing water flow, rain, etc. Water level 14b remains below the surface of roadway 16 that is dangerously close to flooding the roadway 16 and merits a caution level warning. In some cases, water level 14b may be at the roadway level (for example, due to direct contact by rain) but is not high enough to flood the roadway 16. The water level 14c represents a water level that is risen substantially above the roadway 16 such that the roadway 16 is considered flooded and unsafe to pass through. Thus, water level 14c will trigger an indication that the roadway 16 ahead is flooded and should not be entered.

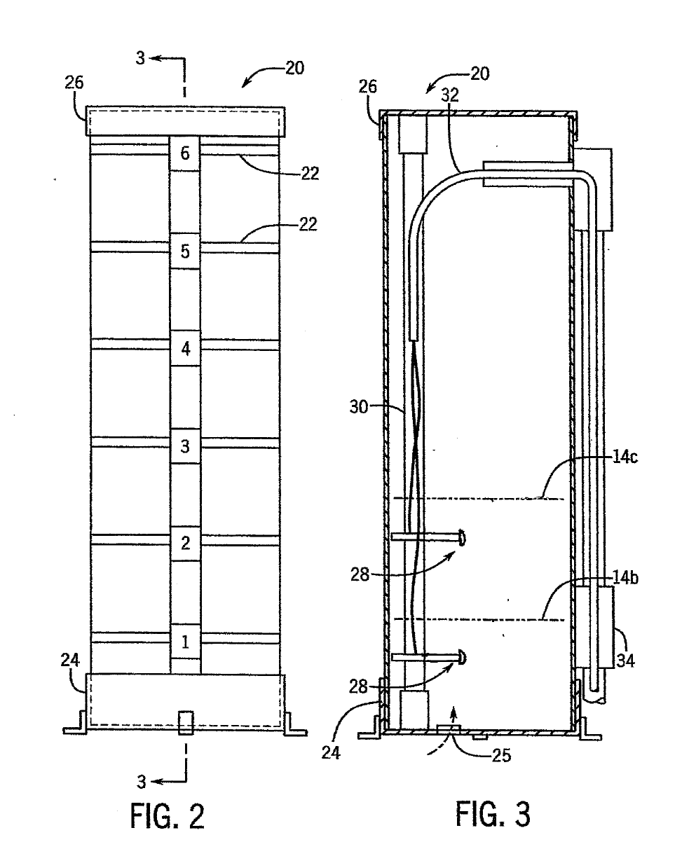

Referring to FIGS. 2 and 3, the gauge unit 20 is shown as used for the monitoring of the water levels 14a, 14b and 14c. Generally, the gauge unit 20 is installed at the lowest elevation point in flood-prone areas. The gauge unit 20 includes a housing secured at a water inlet base 24 the ground adjacent to the waterway but not in the waterway. An inlet port 25 is positioned at the bottom of the inlet base for ingress of water as the level rises. The inlet port 25 could also be positioned on the sides of the housing adjacent to the bottom of the housing. The exterior of the housing may include a reflective water level scale 22 which provides a visible measurement of the current water level inside the housing. The housing is capped off by lid 26 to protect the interior components from damage. The gauge unit 20 is set at the lowest elevation point of the roadway 16 (for example, starting at zero inches from the road surface). The lowest elevation and location of placement may be determined by the user. For example, the gauge unit 20 location could be the shoulder of the roadway 16, the crown in the roadway 16, or even a sidewalk next to the roadway 16.

The interior of the housing includes a plurality of optical sensors 28 that are vertically arranged in spaced relationship to each other within the housing. The plurality of optical sensors 28 measure water depth as water enters through the inlet port. The optical sensors 28 may be coupled to a supporting column rail 30 and is adjustable in height along the rail 30. These are set in positions of water level height according to the user's requirements. By this feature, the predefined stages of water level warnings are programmable for applicability to the height relationship between the roadway 16 and the waterway 14. The optical sensors are positioned in vertically-spaced relationship and generally directed toward the interior of the housing. These optical sensors are very low-powered optical sensors that will sense the level of water within the housing. The optical sensors avoid the need for float sensor switches or other mechanical devices that could easily fail under those circumstances of water and debris intrusion. Optical sensors are not prone to corrosion. Float switches of the prior art were found to be prone to failure. After water intrusion would occur, certain amount of corrosion or debris accumulation would occur. This corrosion and debris accumulation could affect the ability of the float switches to move to their desired position under those conditions of flooding. As such, these optical sensors avoid the corrosion and the adverse effect of debris accumulation. Additionally, optical sensors are relatively easy to install and are relatively inexpensive. The signals from the optical sensors 28 can trigger a signal sent along a power and control cable 32 within the rail 30 to a junction box 34. The power and control cable 32 may be routed outside the housing to the control unit 40 as discussed above. At the very least, the signal from the power and control cable 32 is transmitted to the control unit 40 and/or display 70. FIG. 3 shows that the bottommost optical sensor 28 has been raised high enough to indicate that the water level 14 has been reached and is at warning levels. In addition, the next optical sensor 28 is positioned above the triggering point for the flooded water level 14c so as to generate the flooded signal.

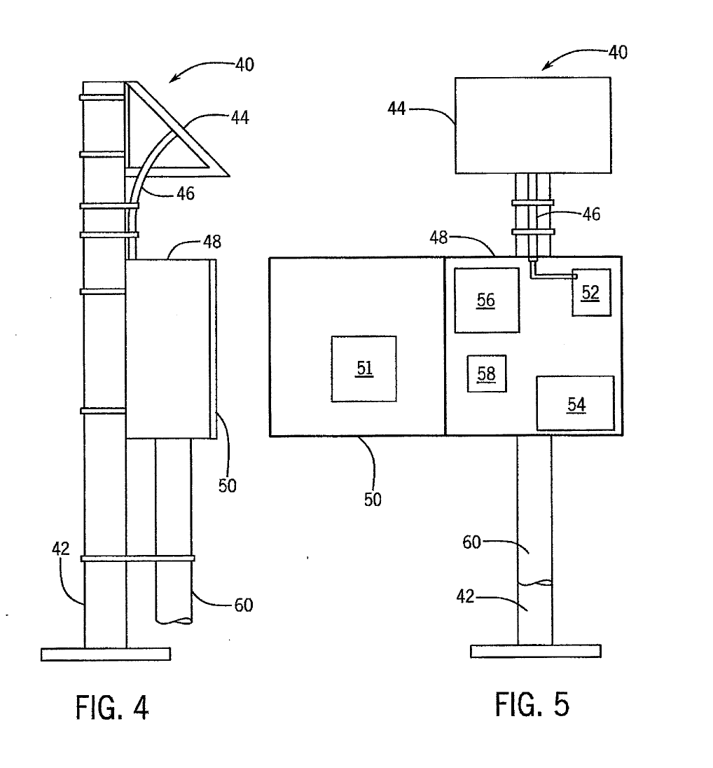

Referring to FIGS. 4 and 5, in conjunction with FIG. 1, the control unit 40 is shown. The control unit 40 is installed at a higher elevation in the area adjacent the gauge unit 20. The control unit 40 is mounted on support stand 42 so as to give the control unit 40 the ability to be moved up or down in order to remain out of the flood waters. The control unit 40 includes a power supply 58 powered by an incoming power source to a conduit 60. Alternatively, the control unit could also include a solar panel and battery so as to provide the requisite power for the transmission of signals from the gauge unit 20 to the display 70.

The optical sensors 28 may be coupled to a solar panel or to a battery provide power through wiring 46 which is managed by a solar controller 52. A battery 54 can be connected to the solar panel so as to store power provided by the solar panel. The battery 54 can be connected to the optical sensors so as to provide power to the optical sensors. The battery can also provide power to the optical sensors under those circumstances where the solar power is not available. The control unit 40 is housed in an enclosure 48 which is accessible by a door 50. A controller 56 is inside the enclosure 48. The controller has two functions. One of the function is to take the information from the gauge unit 20 and the other is to control the lights of the display 70. In response to the signal from the gauge unit 20, the controller 56 sends a signal to the display 70 to turn on or turn off lights so as to represent the different water level stages. As shown in these figures, one optical sensor is positioned at a level within the gauge unit 20 that is higher than the level of water in the waterway when the water level of water in the waterway is at the low position. Another optical sensor 28 is positioned at a level within the gauge unit that is above a surface of the roadway adjacent to the waterway. As such, the lowermost optical sensor would generally show that there is no water within the housing during normal non-flooded conditions. When flooding starts to occur, the water level within the waterway will rise in eventually reach the level of the lower most optical sensor 28. This would send a signal so as to illuminate a caution indicator on the display 70. As water within the waterway continues to rise, the water within the enclosure of the gauge unit 20 will eventually reach the upper optical sensor 28. This would then transmit a signal to the display that the area is flooded and that a flooded condition be provided on the display 70.

FIGS. 6 and 7 show an exemplary embodiment of the display 70. The display 70 provides a motorist or pedestrian with a clear visible signal of the current flood level information. A housing 71 is supported on a stand 72. The housing 71 may include a plurality of warning lights 74. Three lights 74a, 74b, and 74c are shown which when illuminate represent water levels 14a, 14b and 14c, respectively. These would respectively be indicative of safe conditions, caution conditions, and flooded conditions. The display 70 can be wirelessly connected to the control unit 40 (of FIG. 4) and receives the signal from the control unit 40 through a wire track 76 then through the housing through junction box 78. The light 74 may be colored to provide a visual cue of the current flood level. For example (referring back to FIG. 3 in conjunction with FIG. 7), when the lowest optical sensor 28 remains un-triggered, the signal sent to the display 70 would illuminate light 74a. This would be the color green to indicate that the roadway 16 ahead is safe to traverse. In response to the lowest optical sensor 28 being triggered, the light 74b (which may be of a yellow color) would be illuminated to indicate the water level is currently high and in danger of flooding the roadway 16 ahead. As such, caution should be used in proceeding through. Generally, as warning light 74 is illuminated, the previously illuminated warning light is turned off. In response to the uppermost optical sensor 28 being triggered, the warning light 74c (of a red color) is illuminated to indicate that the roadway 16 ahead is flooded and should not be traversed.

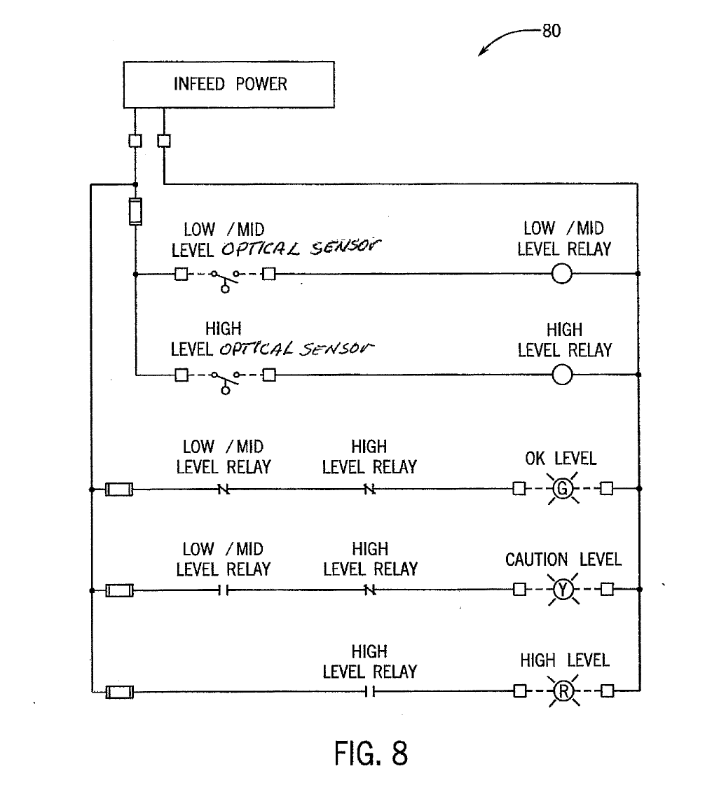

FIG. 8 shows an electrical logic schematic 80 for lighting the warning light 74 described above. A set of relays may be opened or closed to illuminate or turn off lights 74a, 74b, or 74c depending on the conditions provided by the signals described.

Persons having ordinary skill in the art may appreciate that various modifications can be made to the claimed invention without the prior from the spirit of the invention. For example, while the gauge unit was described as using a plurality of optical sensors, other embodiments can use a single sensor that is configured to rise with the water level and trigger based on water height measured. Other embodiments could use a different type of sensor, other than an optical sensor, while still achieving similar effectiveness of the disclose system. Also, while colored lights as the warning lights in the display, other visual cues could also be used including text-based warnings audible warnings, and mechanical warnings, (such as a gate that is closed in response to the flooded condition).

The foregoing disclosure and description of the invention is illustrative and explanatory thereof. Various changes in the details in the steps of the described process or in the details of the system may be made within the scope of the present claims without departing from the true spirit of the invention. The present invention should only be limited by the following claims and their legal equivalents.

I claim:

1. A process for detecting a level of water in a waterway and for providing a warning of the level of water in the waterway, the process comprising:
positioning a gauge unit in a location on a surface away from the waterway when the level of water in the waterway is at a low position;
sensing a level of water within the gauge unit when the level of water in the waterway raises above the low position;
positioning a display at a location remote from the waterway and adjacent to a roadway;
transmitting a signal from the gauge unit to the display relative to the level of water in the gauge unit; and
displaying an indicator on the display relative to the transmitted signal, the indicator providing information to a person on or at the roadway relative to the level of water in the waterway.

2. The process of claim 1, further comprising:
flowing water from the waterway into a lower end of the gauge unit such that the water in the gauge unit raises or lowers relative to the level of water in the waterway.

3. The process of claim 2, the step of sensing comprising:
optically sensing the level of water.

4. The process of claim 3, further comprising:
applying a plurality of optical sensors arranged in vertically spaced relationship within the gauge unit, the plurality of optical sensors directed toward an interior of the gauge unit.

5. The process of claim 1, the step of displaying an indicator comprising:
forming an enclosure having a plurality of lights thereon, the plurality of lights being directed toward the roadway in a direction away from the waterway.

6. The process of claim 5, the plurality of lights being of different colors, the step of transmitting the signal comprising:
transmitting the signal to the plurality of light so as to illuminate a first color when the water in the gauge unit has not reached a first level in the gauge unit.

7. The process of claim 6, further comprising:
transmitting another signal to the plurality of lights so as to illuminate a second color when the water in the gauge unit has reached a second level in the gauge unit.

8. The process of claim 7, the step of transmitting the signal further comprising:
transmitting a further signal to the plurality of lights so as to illuminate a third color of the plurality of lights when the water in the gauge unit has reached a third level in the gauge unit.

9. The process of claim 8, the first signal being indicative of a safe condition, the second signal being indicative of a near-flooded condition, the third signal being indicative of a flooded condition.

10. The process of claim 9, the first color being green, the second color being yellow, the third color being red.

11. The process of claim 6, further comprising:
applying a plurality of optical sensors arranged in vertically-spaced relation within the gauge unit, the plurality of optical sensors being directed toward an interior of the gauge unit, the first color being illuminated when the water in the gauge unit is below a lowermost optical sensor of the plurality of optical sensors.

12. The process of claim 4, the step of applying a plurality of optical sensors further comprising:
applying an optical sensor at a level within the gauge unit that is higher than the level of water in the waterway when the level of water in the waterway is at the low position; and
applying another optical sensor at a level within the gauge unit that is higher than a surface of the roadway adjacent to the waterway.

13. A flood warning system comprising:
a gauge unit adapted to be positioned adjacent to a waterway, said gauge unit having a plurality of sensors arranged in vertically-spaced relation within a housing of the gauge unit, the housing having a fluid inlet adapted to allow water to enter the housing when the level of water in the waterway is raised above a low position, said plurality of sensors adapted to detect a level of water within the housing of the gauge unit; and
a display adapted to be positioned away from the waterway and adjacent to a roadway, the display having a warning indicator thereon, said display being cooperative with said gauge unit such that the warning indicator is actuated when the level of water in the housing of the gauge unit is above one of said plurality of sensors.

14. The flood warning system of claim 13, said plurality of sensors being a plurality of optical sensors.

15. The flood warning system of claim 14, said plurality of optical sensors comprising:
a first sensor positioned at a level higher than the low position of the level of water in the waterway; and
a second sensor positioned at a level higher than a surface of the roadway adjacent to the waterway.

16. The flood warning system of claim 13, said plurality of sensors being adjustably positioned within said housing.

17. The flood warning system of claim 13, the display having a housing with a plurality of lights positioned thereon, said plurality of lights being directed away from the waterway, said plurality of lights corresponding to the level of water within the waterway.

18. The flood warning system of claim 17, one of said plurality of lights being green, another of said plurality of lights being red, the green being indicative of a non-flooded roadway, the red being indicative of a flooded roadway.

19. The flood warning system of claim 13, further comprising:
a solar panel affixed to said housing; and
a battery connected to said solar panel, said battery supplying power to the plurality of sensors in said gauge unit.

20. The flood warning system of claim 13, said gauge unit being wirelessly connected to said display such that signals from said plurality of sensors are transmitted wirelessly to said display.
